(19) United States
(12) Patent Application Publication
(10) Pub. No.: US 2010/0165958 A1
(43) Pub. Date: Jul. 1, 2010

(54) SYSTEM AND METHOD FOR FACILITATING FAIR ASSOCIATION OF CLIENT DEVICES WITH ACCESS POINTS IN A WIRELESS COMMUNICATION SYSTEM

(75) Inventors: Soumya Roy, Bangalore (IN); Shantanu Biswas, Bangalore (IN); Anurag Goyal, New Delhi (IN)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Schaumburg, IL (US)

(21) Appl. No.: 12/345,831

(22) Filed: Dec. 30, 2008

(51) Int. Cl. H04W 60/00

(52) U.S. Cl. 370/338

(57) ABSTRACT

A method for facilitating association of a client device with an access point in a wireless communication system is disclosed. The method comprises the access point receiving at least one client parameter and required throughput from the client device. The access point computes an achievable transmission rate for the client device based on the client parameter. The access point then estimates throughput for the client device based on the achievable transmission rate. Thereafter, the access point computes a utility value considering an association with the client device. The utility value is based oil the estimated throughput and the required throughput of the client device. The access point then determines a possibility of an association of the client device based on the utility value.

### FIELD OF THE DISCLOSURE

The present disclosure, in general, relates to wireless communication systems, and in particular, relates to association of client devices with access points in a wireless communication system.

### BACKGROUND

The advent of wireless communication has led to significant advancement in the field of telecommunication. There has been a wide proliferation of Wireless Local Area Networks (WLANs), especially in small and medium-sized enterprises. The WLANs include Access Points (APs) and clients compliant with certain wireless communication standards, such as IEEE 802.11. Such WLANs are popular because of their low cost, ease of deployment and support for high bandwidth. However, most of such deployments have been stand-alone, unplanned and catered towards individual needs. This has led to dense, overlapping WLANs without any coordination between the APs. Moreover, in such WLANs, the clients associate with the APs based on the highest signal strength of beacon signals received from the APs. This causes an uneven distribution of the clients in a coverage area. In such cases, an AP in the vicinity of a large number of clients gets heavily loaded and a distant AP remains sparingly loaded. This leads to unfair association of clients with APs, and thus, some clients starve for bandwidth, while others have high available bandwidth.

One of the existing solutions that deal with the problem of uneven load distribution is a load balancer for self-adaptive load balancing between APs in a WLAN. The load balancer tracks a telemetry parameter of each wireless client's wireless link with each respective AP and compares the tracked telemetry parameter against a predetermined goal to obtain a fitness measure. Based on the fitness measure, functioning of an AP is varied to balance the distribution of clients among the respective access points. Though this solution suggests a technique for balancing load on the APs by tracking the telemetry parameter of a client's link, it does not ensure fair association of the clients with the APs.

Another existing solution is a technique for providing fairness and load balancing in WLANs using association control. In this technique, a network operation center receives user information from each client via access points. The network operation center then determines set of associations between each client and one or more access points based on the user parameters using functional load balancing. Thereafter, a second set of associations is determined in which each client is associated with only one respective AP. This technique involves dependence on the network operation center for providing load balancing and fairness, and is thus not scalable. Deploying a centralized network based on this technique can be cost intensive and requires considerable expertise.

Accordingly, there is a need for an improved system and a method for fair association of clients and APs in a wireless communication system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 is a system diagram of a wireless communication system in accordance with some embodiments.

FIG. 2 is a block diagram illustrating an access point employed in the wireless communication system of FIG. 1 in accordance with some embodiments.

FIGS. 3A and 3B illustrate a flowchart of a method for facilitating a fair association of a client device with an access point in accordance with some embodiments.

FIG. 4 illustrates a message transfer sequence among the access points and tile client devices in accordance with some embodiments.

FIG. 5 illustrates a wireless communication system having various client devices seeking associations with access points in accordance with some embodiments.

FIG. 6 illustrates association of the client devices with the respective access points in the wireless communication system of FIG. 5 in accordance with some embodiments.

FIG. 7 illustrates a change in associations of the client devices and the access points in the wireless communication system due to an addition of a new client device.

FIG. 8 illustrates a change in associations of the client devices and the access points in the wireless communication system due to a disassociation of an existing client device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The present disclosure is directed towards a method for facilitating an association of a client device with an access point in a wireless communication system. In one embodiment, the access point receives at least one client parameter and required throughput from the client device. Based on the received client parameter, the access point computes an achievable transmission rate for the client device. The access point then estimates throughput for the client device based on the achievable transmission rate. After estimating the throughput, the access point computes a utility value for the client device, considering an association with the client device. Depending upon the utility value, the access point determines whether to allow the client device to associate with the access point. The access point can make such a determination by comparing the determined utility value with other utility values computed by other access points with which the client device can potentially associate. The client device associates with the access point if the determined utility value is highest among the other utility values.

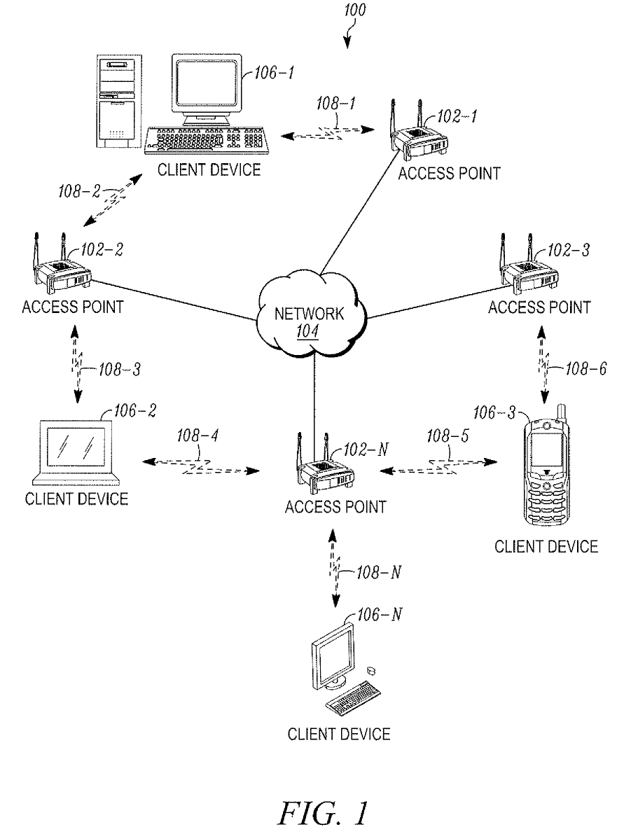

FIG. 1 is a system diagram illustrating a communication system in which methods and apparatuses, consistent with some embodiments of the present disclosure can be implemented. Specifically, FIG. 1 illustrates a wireless communication system 100 such as a Wireless Local Area Network (WLAN) defined in wireless standards such as IEEE 802.11 communication standard (For any IEEE standards recited herein, see: http://standards.ieee.org/getieee802/index.html or contact the IEEE at IEEE, 445 Hoes Lane, PO Box 1331, Piscataway, N.J. 08855-1331, USA.) As shown in FIG. 1, the wireless communication system 100 includes a plurality of wireless access points (AP) 102-1 to 102-N, collectively referred to as access points (APs) 102. The APs 102 are connected to a network 104. The network 104 can be any wired or wireless network such as Local Area Network (LAN), Metropolitan Area Network (MAN), or Wide Area Network (WAN). The network 104 can include various network devices such as servers, clients, routers, switches, hubs, repeaters, multiplexers, de-multiplexers, and the like. The network 104 may also refer to the Internet. The wireless communication system 100 further includes a plurality of client devices 106-1 to 106-N, collectively referred to as client devices 106. The client devices 106 include, but not limited to, personal computers, laptops, mobile phones, Personal Digital Assistants (PDAs), and the like. In present embodiment, the APs 102 and the client-devices 106 operate in IEEE 802.11 b/g infrastructure mode. However, it is to be understood that the APs 102 and the client devices 106 can operate in accordance with any other wireless communication standards and that the operation of the APs 102 and the client devices 106 in IEEE 802.11 b/g is not to be considered as a limitation on an embodiment of the present disclosure. It will be appreciated by those of ordinary skill in the art that any number of APs 102 and client devices 106 can be utilized within the wireless communication system 100 in accordance with the embodiments, and that the quantity of such devices in FIG. 1 are for illustrative purposes only.

The client devices 106 can access the network 104 by associating with the access points 102. In one embodiment, each of the client devices 106 is in a coverage area of the one or more APs 102. The client devices 106 can associate with one of the APs 102, based on the coverage area of the APs 102. For example, in FIG. 1, the client device 106-1 is illustrated to be in the coverage area of the APs 102-1 and 102-2, as indicated by wireless links 108-1 and 108-2. The client device 106-1 can associate with either of the two APs 102-1 or 102-2.

In accordance with some embodiment, each of the APs 102 determines which of the client devices 106 to associate with based on the current load on the respective AP and throughput requirement of the client devices 106. Each of the APs 102 receives some client parameters and throughput requirement from the client devices in their respective coverage areas. APs 102 compute utility values for the client devices 106 based on the client parameters and the throughput requirements received from the client devices. The APs 102 use the computed utility values to facilitate fair association of client devices 106 with the APs 102.

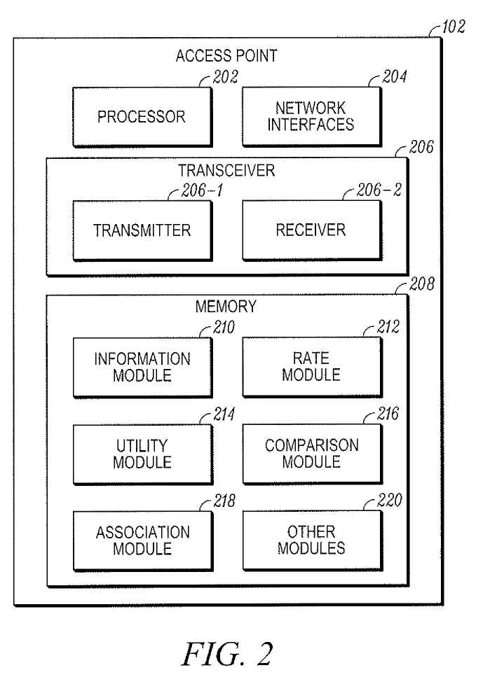

FIG. 2 is a block diagram illustrating some components that can be implemented in the access point 102 shown in FIG. 1 in accordance with some embodiments. The AP 102 includes a processor 202, one or more network interfaces 204 for establishing connection with the client devices 106 and other APs present in the wireless communication system 100, a transceiver 206, and a memory 208 for storing operating instructions that are executed by the processor 202. Although not shown, the AP 102 also can include an antenna, a duplexer, a circulator, or other highly isolative means for intermittently providing data from the transceiver 206 to the antenna and from the antenna to the transceiver 206. The AP 102, for example, can be an integrated unit containing at least all the elements depicted in FIG. 2, as well as any other elements necessary for the AP 102 to perform its particular functions. Alternatively, the AP 102 comprises a collection of appropriately interconnected units or devices, wherein such units or devices perform functions that are equivalent to the functions performed by the elements of AP 102.

The processor 202 includes one or more microprocessors, microcontrollers, DSPs (Digital Signal Processors), state machines, logic circuitry, or any other device or devices that process information based on operational or programming instructions. Such operational or programming instructions are stored in the memory 208. The memory 208 can be an IC (Integrated Circuit) memory chip containing any form of RAM (Random Access Memory) or ROM (Read-Only Memory), a floppy disk, a CD-ROM (Compact Disk Read-Only Memory), a hard disk drive, a DVD (Digital Video Disc), a flash memory card or any other medium for storing digital information. One of ordinary skill in the art will recognize that when the processor 202 has one or more of its functions performed by a state machine or logic circuitry, the memory 208 containing the corresponding operational instructions can be embedded within the state machine or logic circuitry.

The transceiver 206 includes a transmitter 206-1 and a receiver 206-2. The transceiver 206 enables the AP 102 to communicate data packets to and acquire data packets from the client devices 106 and other devices in the wireless communication system 100. In this regard, the transmitter 206-1 and the receiver 206-2 include conventional circuitry to enable digital or analog transmissions over a wireless communication channel. The transceiver 206 is designed to operate over air interface such as 802.11 WLAN, 802.16 WiMax (Worldwide Interoperability for Microwave Access), and the like.

The implementations of the transmitter 206-1 and the receiver 206-2 depend on the implementation of the AP 102. For example, the transmitter 206-1 and the receiver 206-2 can be implemented as an appropriate wireless modem, or as conventional transmitting and receiving components of two-way wireless communication devices. Most, if not all, of the functions of the transceiver 206 can be implemented in a processor, such as the processor 202.

The memory 208 includes various modules containing instructions that can be executed by the processor 202 for functioning of the AP 102. The functioning of the AP 102 is explained using the modules to facilitate better understanding. However, the modules included in the AP 102 are not meant to be a limitation on an embodiment of the present disclosure.

In one embodiment, the memory 208 includes an information module 210, a rate module 212, a utility module 214, a comparison module 216, an association module 218, and other modules 220 such as operating system, application software and the like required to support functioning of the AP 102.

The information module 210 stores instructions and data related to the client devices 106 and data received from the other APs. The information module 210 receives client parameters and throughput requirements from the client devices in the coverage area of the AP 102. For example, the information module 210-N included in the AP 102-N can receive client parameters and throughput requirements from client devices 106-2, 106-3, and 106-N. The client parameters may include Signal-to-Noise Ratio (SNR) information for beacon signals received by the client devices 106 from the respective APs. Other client parameters can include Bit Error Rate (BER), signal strength, channel rate, or any other appropriate physical layer or link layer parameters associated with the client devices 106. The throughput requirement of a client device is the minimum average rate of successful message delivery that the client device expects from an associated access point. The AP 102 ensures fairness to each of the client devices seeking associations with the AP 102 based on the throughput requirements of the client devices 106.

The rate module 212 performs functions such as computation of achievable transmission rates and throughputs for the client devices 106. In one embodiment, the rate module 212 receives client parameters from the information module 210, and processes the received client parameters to determine achievable transmission rates for the respective client devices. The achievable transmission rate is the average rate at which an access point can transmit data to an associated client device. Based on the achievable transmission rates, the rate module 212 prepares a list of potential client devices that can be associated with the AP 102. In one example, the rate module 212 sorts the potential client devices within the list in the order of decreasing transmission rates of the potential client devices, with the client device having maximum achievable transmission rate at the top of the list. The rate module 212 further uses the achievable transmission rates to estimate throughput for the potential client devices. In one implementation, the rate module 212 estimates the throughput using formula:

$${T}_{ij} = 1 / {\sum }_{k}^{ } 1 / {R}_{kj}$$

where,
Tᵢⱼ is an estimated throughput of a client device i seeking an association with an AP j; and
Rₖⱼ is the transmission rate of a client device k when associated with the AP j.

The utility module 214 computes a utility value for each potential client device within the wireless communication system 100 with which the AP 102 is considering an association. The utility module 214 receives the throughput requirement and the estimated throughput of a potential client device from the information module 210 and the rate module 212, respectively. Based on the throughput requirement and the estimated throughput of a given potential client device, the utility module 214 computes a utility value considering an association with the potential client device. As used herein, the term utility value is defined as a measure of fairness offered to a given potential client device by the AP 102, when the potential client device associates with the AP 102. In one implementation, the utility value is computed as a logarithmic function of the estimated throughput and the throughput requirement of the potential client device. For example, the utility value can be represented as:

Uᵢⱼ=log(Tᵢⱼ/Qᵢ)

where,
Uᵢⱼ is a utility value computed by an AP j considering an association with a client device i;
Tᵢⱼ is an estimated throughput of a client device i seeking an association with an AP j; and
Qᵢ is the throughput requirement of the client device i.

The comparison module 216 determines whether an association of a client device for the AP 102 is fair or not. In one example, the comparison module 216 compares the utility value computed by the AP 102-N for the client device 106-2, with utility values computed by other APs having the client device 106-2 in their coverage areas. If the utility value computed by the AP 102-N is greater than all other utility values, the client device 106-2 associates with the AP 102-N. Otherwise, the AP 102-N either drops the client device 106-2 from the list of potential client devices, or lets the client device 106-1 remain as a potential client device that can associate with the AP 102-N when possible.

The association module 218 associates an appropriate client device with the AP 102, as determined by the comparison module 216. The association module 218 notifies the client device about the association. The association module 218 also maintains a list of client devices currently associated with the AP 102.

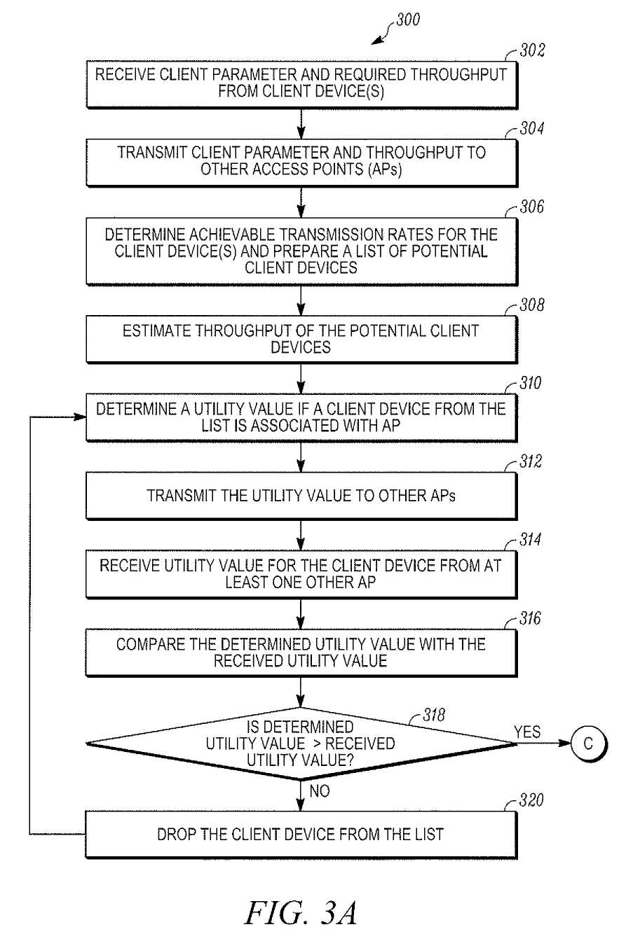

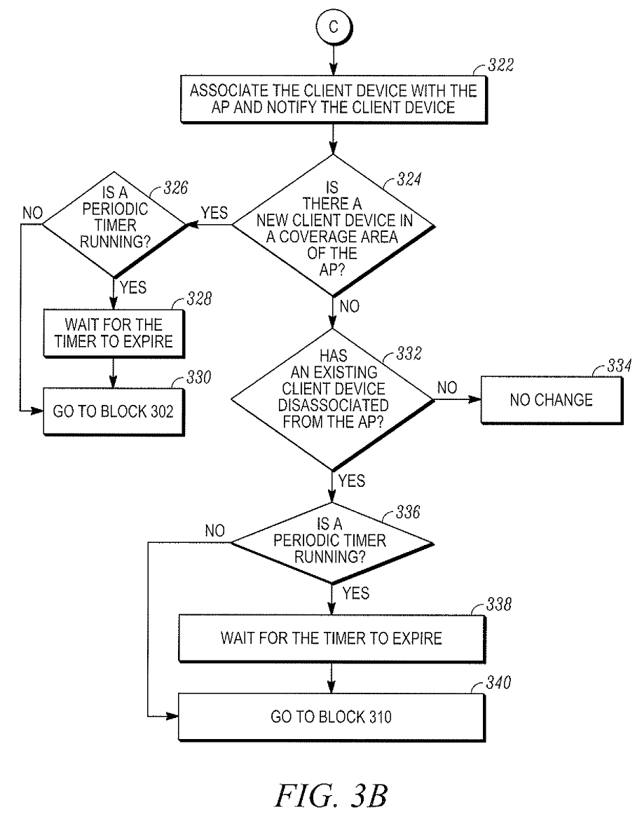

FIGS. 3A and 3B illustrate a flowchart of a method 300 for a fair association of a client device with an access point in accordance with some embodiments. Note that FIG. 3A illustrates blocks 302 through 320 of the method 300 and the same method 300 is continued to blocks 322 through 336 in FIG. 3B. The method 300 is explained with reference to FIGS. 1 and 2. In addition, to facilitate better understanding, the method 300 is explained with respect to the AP 102-N and the client devices in its coverage area, for example, client devices 106-2, 106-3, and 106-N as shown in FIG. 1.

At block 302, an AP 102 receives client parameters and throughput requirements from one or more client devices 106 present in the coverage area of the AP 102. In one embodiment, the AP 102-N sends a beacon signal to each of the client devices 106-2, 106-3 present in the coverage area of the AP 102-N. The client devices 106-2, 106-3, and 106-N measure the respective SNR based on the beacon signal received from the AP 102-N. The client devices 106-2, 106-3, and 106-N then send client parameters such as measured SNR to the AP 102-N. Along with the client parameters, the client devices 106-2, 106-3, and 106-N also send their respective throughput requirements to the AP 102-N.

At block 304, the AP 102 transmits the received client parameters and throughput requirements to other APs in the wireless communication system 100 via the network 104. In one embodiment, the AP 102-N transmits the received client parameters and throughput requirements of the client devices 106-2, 106-3, and 106-N to the APs 102-1, 102-2, and 102-3 to inform them about the client devices 106-2, 106-3, and 106-N present in the coverage area of the AP 102-N. Similarly, the AP 102-N also receives information about the client devices in the coverage areas of other APs, for example APs 102-1, 102-2, and 102-3, in the wireless communication system 100.

At block 306, the AP 102 determines achievable transmission rates for the client devices 106. In one embodiment, the AP 102-N determines the achievable transmission rates for the client devices 106-2, 106-3, and 106-N based on the respective client parameters. The AP 102-N also prepares a list of potential client devices that can be possibly associated with the AP 102-N. In one example, the AP 102-N sorts the potential client devices based on their respective achievable transmission rates.

At block 308, the AP 102 estimates throughput for the potential client devices. In one embodiment, the AP 102-N estimates the throughput for the client devices 106-2, 106-3, and 106-N by considering respective transmission rates of the client devices that are pre-associated with the AP 102-N, where the transmission rates refer to rates at which the AP 102-N transmit data to the client devices already associated with it.

At block 310, the AP 102 determines a utility value for a potential client device in the list. In one embodiment, the AP 102-N selects one of the client devices 106-2, 106-3, and 106-N based on the sorted list. For example, the AP 102-N can select a client device that has the maximum achievable transmission rate among other potential client devices identified in the list. After selecting a client device, for example, client device 106-2, the AP 102-N determines the utility value for the client device 106-2 based on the estimated throughput and the required throughput of the client device 106-2. In present embodiment, the utility value is a logarithmic function of the estimated throughput and the required throughput.

At block 312, the AP 102 transmits the utility value to the other APs in the wireless communication system 100. In one example, the AP 102-N transmits the determined utility value for the client device 106-2 to the APs 102-1, 102-2, and 102-3.

At block 314, the AP 102 receives one or more utility values from the other APs in the wireless communication system 100. In one example, the AP 102-N receives the utility value for the client device 106-2 from the AP 102-2.

At block 316, the AP 102 compares the determined utility value with the received utility values. In one example, the AP 102-N compares the determined utility value for the client device 106-2 with the utility value received from the AP 102-2.

At block 318, the AP 102 checks if the determined utility value is greater than the received utility value(s). In one example, the AP 102-N checks whether the utility value determined for the client device 106-2 is greater than the utility value received from the AP 102-2. If the AP 102-N determines that the utility value for the client device 106-2 is greater than the utility value received from the AP 102-2, the AP 102-N follows instructions at block 322 as shown in FIG. 313. On the other hand, if the AP 102-N determines that the utility value for the client device 106-2 is less than the utility value received from the AP 102-2, the AP 102-N follows instructions at block 320.

At block 320, the AP 102 drops the client device 106 from the list. In one example, the AP 102-N drops the client device 106-2 from the list of potential clients, when the determined utility value for the client device 106-2 as determined by the AP 102-N is less than the utility value for the client device 106-2 as received from the AP 102-2. In an alternate embodiment, the client device 106-2 remains as a potential client device for the AP 102-N and associates with it when possible. After dropping the client device 106-2, the AP 102-N re-iterates the instructions from the block 310.

At block 322, the AP 102 allows an association with the client device for which it is having the maximum utility value with itself. In one embodiment, the client device 106-2 associates with the AP 102-N, when the determined utility value for the client device 106-2 as determined by the AP 102-N is greater than the utility value for the client device 106-2 as received from the AP 102-2. The AP 102-N notifies the client device 106-2 about the association. The AP 102-N may also notify APs 102-1, 102-2, and 102-3 about the association with the client device 106-2.

At block 324, the AP 102 checks if there is a new client device in its coverage area. In one embodiment, the AP 102-N checks whether any new client device has entered in the coverage area of the AP 102-N. If the AP 102-N finds a new client device, the AP 102-N follows instructions at block 326. On the other hand, if the AP 102-N does not find a new client device, the AP 102-N follows instructions at block 332.

At block 326, the AP 102 checks if a periodic timer is running. In one embodiment, the AP 102-N includes a timer, that tracks the time elapsed since the previous computations of the utility values. To avoid computation overheads, the AP 102-N specifies a time period after which it can re-compute the utility values. At block 328, the AP 102-N waits for the timer to expire. In other words, the AP 102-N waits for the pre-specified time period to lapse.

At block 330, the AP 102 re-iterates the method 300 from the block 302. In one embodiment, if the AP 102-N finds a new client device, the AP 102-N repeats instructions at all blocks from the block 302 to ensure that the new client device gets fair association.

At block 332, after determining that no new client has entered the coverage area, the AP 102 checks whether an existing client device has disassociated from the AP 102. In one example, the client device 106-N may disassociate from an AP 102-N due to powering down of the client device 106-N, any device failure in the client device 106-N, or due to the departure of the client device 106-N from the coverage area of the AP 102-N. If the AP 102-N determines that none of the existing client devices has dissociated, the AP 102-N follows instructions at block 334. On the other hand, if the AP 102-N determines that an existing client device has disassociated, the AP 102-N follows instructions at block 336.

At block 332, when the AP 102 determines that all the existing client devices are still associated with the AP 102, the AP 102 determines that no change is required in the wireless communication system 100. In one example, the AP 102-N refrains from making any change in associations with the existing client devices, if none of the existing client devices has disassociated.

At blocks 336 and 338, the AP 102-N checks if a periodic timer is running and waits for the timer to expire, similar to that described for the blocks 326 and 328.

At block 340, the AP 102-N re-iterates the method 300 from the step 310 onwards. The AP 102-N re-computes the utility values and determines the change in the utility values. The client devices 106 may re-associate with different APs based on the change in the utility values. This ensures that the client devices 106 associate with the APs having maximum utility values.

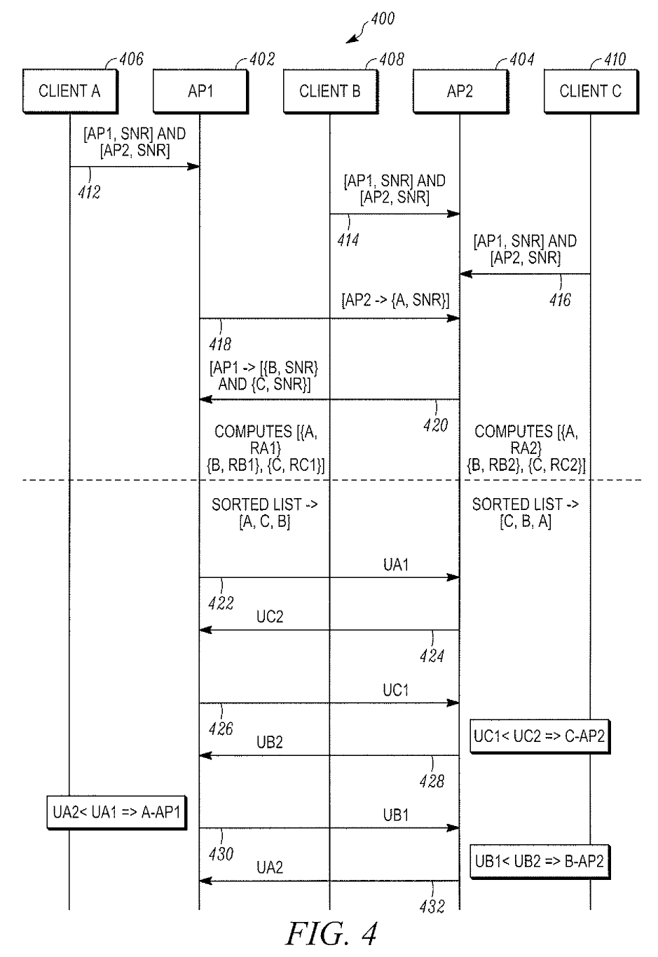

FIG. 4 illustrates a message transfer sequence 400 among access points and client devices in accordance with some embodiments. Consider a wireless communication system including two access points AP1 402 and AP2 404, and three client devices client A 406, client B 408, and client C 410. Both the access points AP1 402 and AP2 404 are similar to APs 102 as described above in FIGS. 1 and 2, and all the client devices client A 406, client B 408, and client C 410 are similar to the client devices 106 as described above in FIGS. 1 and 2.

In one embodiment, the AP1 402 receives a message 412 including SNR information for the AP1 402 as well as for the AP2 404 from the client A 406. The message 412 also includes throughput requirement of the client A 406. Similarly, the AP2 404 receives a message 414 from the client B 408, and a message 416 from the client C 410.

After receiving the message 412 from the client A 406, the AP1 402 sends a message 418 to AP2 404. The message 418 includes the SNR information of the client A 406 as received by the AP1 402 from the client A 406. The message 418 can also include the throughput requirement of the client A 406. Similarly, the AP2 404 sends a message 420 to the AP1 402. The message 420 includes the SNR informational of the client B 408 and the client C 410 as received by the AP2 404 from the client B 408 and the client C 410.

The AP1 402 computes achievable transmission rates RA1, RB1, and RC1 for the respective client devices A 406, B 408, and C 410 based on the respective SNR information. Similarly, the AP2 404 computes achievable transmission rates RA2, RB2, and RC2 for the respective client devices A 406, B 408, and C 410 based on the respective SNR information. Thereafter, both AP1 402 and AP2 404 prepare lists of potential client devices based on the achievable transmission rates. In one embodiment, the AP1 402 and AP2 404 may sort the lists of potential client devices in the decreasing order of the achievable transmission rates. In one embodiment, the sorted list of AP1 402 is {client A 406, client C 410, client B 408}, and the sorted list of AP2 404 is {client C 410, client B 408, client A 406}. According to the sorted lists, the AP1 402 can offer maximum transmission rate to the client A 406 and the AP2 404 can offer maximum transmission rate to the client C 410. Both AP1 402 and AP2 404 also estimate throughput for the clients A 406, B 408, and C 410 based on transmission rates of client devices pre-associated with them.

Next, the AP1 402 determines a utility value, referred to as UA1, considering an association with the client A 406. UA1 is determined as a logarithmic function of the estimated throughput and the required throughput of the client A 406. The AP1 402 then sends the value UA1 to the AP2 404 via a message 422. Similarly, the AP2 404 determines a utility value, referred to as UC2, considering an association with the client C 410, and subsequently sends the value UC2 to the AP1 402 via a message 424. At this point, both AP1 402 and AP2 404 have utility values for different client devices; therefore, AP1 402 and AP2 404 are unable to determine any association.

The APT 402 determines a utility value for the next client in the list, i.e. client C 410. Then, the AP1 402 sends the utility value for the client C 410, referred to as UC1, to the AP2 404 via a message 426. Similarly, the AP2 404 determines a utility value, referred to as UB2, for the client B 408 and sends it to the AP1 402 via a message 428. Both AP1 402 and AP2 404 now have utility values for the common client C 410. Either AP1 402 or AP2 404 can compare the values UC1 and UC2 to determine fair association. In another embodiment, both AP1 402 and AP2 404 make the comparison between the values UC1 and UC2. In present embodiment, UC2 is greater than UC1, and hence the client C 410 associates with the AP2 404 (as indicated by C-AP2 in FIG. 4). The AP1 402 drops the client C 410 from its list of potential clients.

Thereafter, the AP1 402 determines a utility value for the next client in the list, i.e. client B 408. Then, the AP1 402 sends the utility value for the client B 408, referred to as UB1, to the AP2 404 via a message 430. Similarly, the AP2 404 determines a utility value, referred to as UA2, for the client A 406 and sends it to the AP1 402 via a message 432. Both AP1 402 and AP2 404 now have utility values for the client A 406 and the client B 408. Either of the two access points AP1 402 and AP2 404 compares the utility values for the client A 406 and the client B 408. In the present embodiment, CB2 is greater than UB1, hence the client B 408 associates with the AP2 404 (as indicated by B-AP2 in FIG. 4), and UA1 is greater than UA2, hence the client A 406 associates with the AP1 402 (as indicated by A-AP1 in FIG. 4).

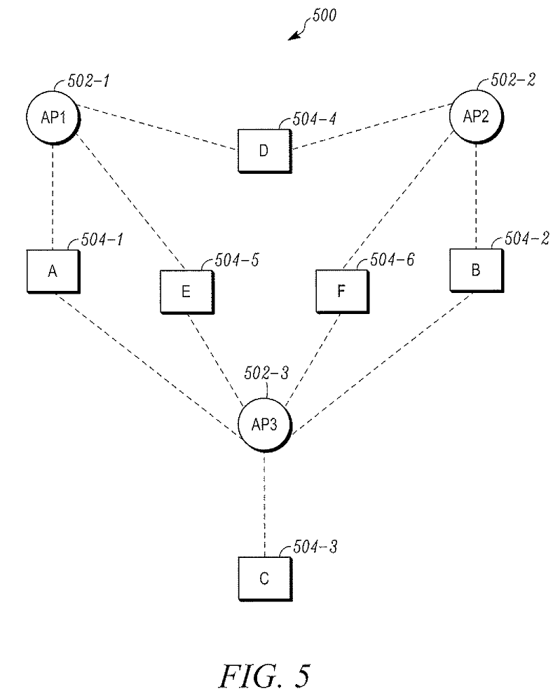

FIG. 5 illustrates a wireless communication system with various client devices seeking association with access points in accordance with some embodiments. The diagram 500 shows three access points AP1 502-1, AP2 502-2, AP3 502-3, collectively referred to as APs 502, and six client devices A 504-1, B 504-2, C 504-3, D 504-4, E 504-5, F 504-6, collectively referred to as client devices 504. The APs 502 and the client devices 504 have similar attributes as those of APs 102 and client devices 106, as shown in FIG. 1. In present embodiment, the AP1 502-1 has three client devices, A 504-1, D 504-4, and E 504-5 in its coverage area. The AP1 502-1 can send beacon signals to at least these three client devices, and thereby receive client parameters and throughput requirements of these client devices. Similarly, the AP2 502-2 has client devices B 504-2, D 504-4, and F 504-6, and the AP3 502-3 has client devices A 504-1, B 504-2, C 504-3, E 504-5, and F 504-6 in their respective coverage areas. It may be noted that the client devices C 504-3 is exclusively in the coverage area of AP3 502-3. Therefore, the client device C 504-3 may associate with the AP3 502-3 by default. In another embodiment, some client devices may associate with a desired AP in accordance with some priority setting, service level agreement (SLA), or any other such requirement.

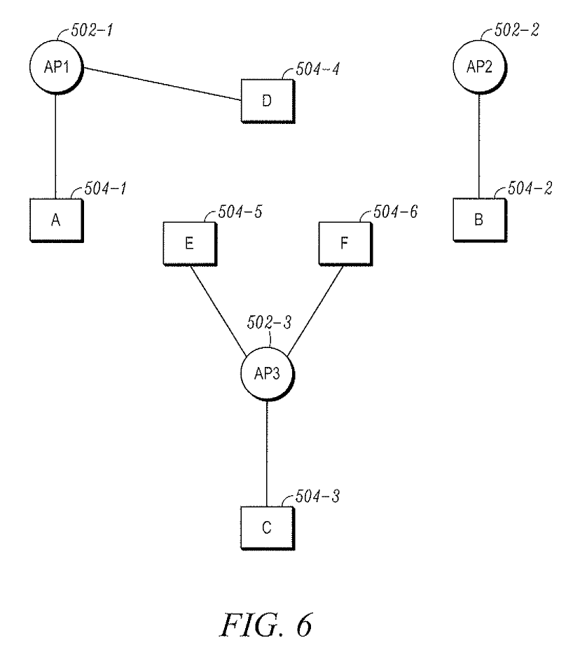

FIG. 6 illustrates the wireless communication system with fair association of the client devices with the respective access points in accordance with some embodiments. In one embodiment, as soon as an AP finds a client device in its coverage area, it triggers a method (see FIGS. 3A and 3B) for fair association of the client device. Accordingly, the client devices 504 associate with APs 502 based on utility values as described above. In present embodiment, the AP1 502-1 has maximum utility values for the client devices A 504-1 and D 504-4, and therefore associates with them. Similarly, the AP 502-2 associates with the client device B 504-2, and the AP3 502-3 associates with the client devices C 504-3, E 504-5, and F 504-6.

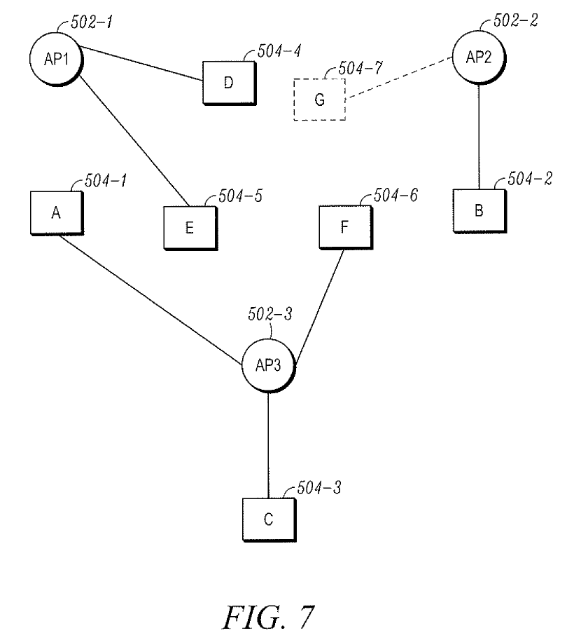

FIG. 7 illustrates a change in the associations of the client devices and the access points in the wireless communication system due to an addition of a new client device in the system. In one embodiment, a new client device G 504-7 enters the wireless communication system and falls within an area covered by all three APs 502. In such a case, each of the APs 502 allow the client device G 504-7 to associate with them based on utility values. Accordingly, the APs 502 re-compute utility values considering an association with the client device G 504-7. Associating with the client device G 504-7 may change the utility values of client devices already associated with the respective APs. This change might lead to re-associations of the client devices 504. In present embodiment, the AP1 502-1 provides maximum utility value to the newly added client device G 504-7, and therefore the client device G 504-7 associates with the AP1 502-1. However, this new association decreases the utility value for tile client device D 504-4 previously associated with the AP1 502-1. To ensure fair association to all the client devices 504, the AP2 502-2 allows the client device D 504-4 to associate with it. Such an association meets throughput requirement of the client device D 504-2 and thus maintains utility value of the system, which is summation of the utility values of the APs present in the wireless communication system 100.

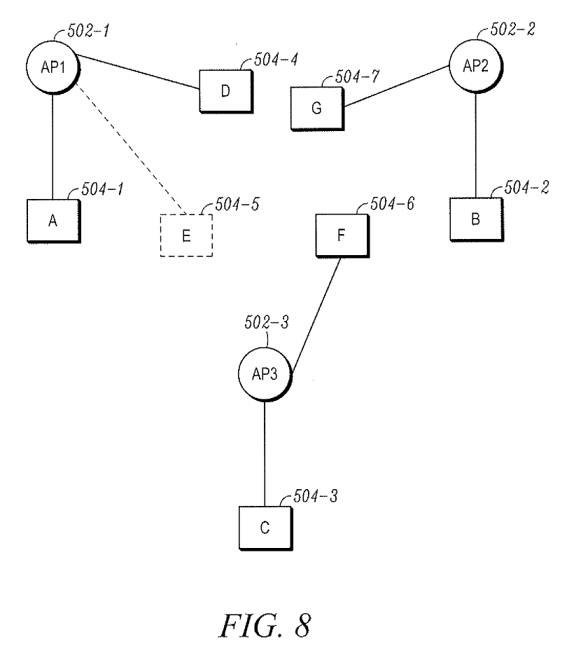

FIG. 8 illustrates a change in the associations of the client devices and the access points in the wireless communication system due to a disassociation of an existing client device. In one embodiment, the client device E 504-5 disassociates from the AP3 502-3 due to reasons such as powering down, device fault, or departure of the device from the coverage area of the AP3 502-3. As soon as the client device E 504-5 disassociates, the AP3 503-3 informs the other APs 502-1 and 502-2 about the disassociation. The APs 502 re-computes the utility values of the client devices 504. If there is no change in the utility values for any of the client devices 504, there is no change in associations of the APs 502 with the client devices 504. However, if there is any change in the utility values, re-associations may take place. In present embodiment, the AP3 502-3 determines that by associating with the client device G 504-7, the AP3 502-3 can increase the utility value for the system. Therefore, the client device C 504-7 gets associated with the AP3 502-3. In addition, the client device D 504-4 leaves the AP2 502-2 and associates with the AP1 502-1, which now provides greater utility value to the client device D 504-4 as compared to that provided by the AP2 502-2.

In one embodiment, the APs 502 compute utility values on a periodic basis as illustrated in FIGS. 3A and 3B. Rather than repeating the whole process for computing the utility values every time a new client device arrives or an existing client device disassociates, the APs 502 can run the process after a pre-determined time interval. The time interval may vary in accordance with dynamics of the wireless communication system.

In one embodiment, a new access point arrives in the wireless communication system as shown in FIG. 5 to FIG. 8. The new AP can have one or more of the client devices 504 in its coverage area. The new AP computes utility values for all the client devices present in its coverage area, and accordingly associates with those client devices for which the new AP has maximum utility values as compared to other APs 502 present in the wireless communication system. In another embodiment, all existing access point, for example AP1 502-1, may disassociate from the wireless communication system. In such a case, all the client devices associated with the AP1 502-1 get disassociate with the AP1 502-1, and thereby seek associations with other APs present in the wireless communication system. The other APs associate the disassociated client devices based on utility values in accordance with embodiments of the present disclosure.

It is to be understood that associations of the access points with the client devices as shown in FIGS. 5-8 are explained by way of specific examples; however, there can be several other possible associations between the access points and the client devices. Moreover, it is possible that initially all the client devices associate randomly with the access points based on parameters such as signal strength. Thereafter, the access points optimize the associations of tile client devices based on utility values.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The above description and the diagrams do not illustrate do not necessarily require the order illustrated.

It will be appreciated that embodiments of the disclosure described herein may be comprised of one or more conventional processors and unique stored program instructions that control the one or more processors to implement, in conjunction with certain non-processor circuits, some, most, or all of the functions of described herein. The non-processor circuits may include, but are not limited to, a radio receiver, a radio transmitter, signal drivers, clock circuits, power source circuits, and user input devices. As such, these functions may be interpreted as steps of a method. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method for facilitating association of at least one client device with all access point in a wireless communication system, the method comprising:
receiving at least one client parameter and required throughput from the at least one client device;
computing an achievable transmission rate for the at least one client device based on the client parameter;
estimating throughput for the at least one client device based on the achievable transmission rate;
computing a utility value considering an association of the at least one client device with the access point, based on the estimated throughput and the required throughput of the client device;
determining whether the at least one client device is to be associated with the access point based on the computed utility value; and
associating the at least one client device with the access point based on the determination.

2. The method of claim 1, wherein the client parameter is a signal-to-noise ratio computed by the client device based on beacon signals received by the client device from the access point.

3. The method of claim 1, wherein the client parameter is at least one of a bit error rate, or signal strength, or channel rate associated with the client device.

4. The method of claim 1, further comprising transmitting the received client parameter and required throughput of the at least one client device to other access points in the wireless communication system.

5. The method of claim 1, wherein the estimating throughput is further based on transmission rate of at least one client device pre-associated with the access point.

6. The method of claim 1, wherein the utility value is a measure of fairness offered to the at least one client device by the access point, when the at least one client device associates with the access point.

7. The method of claim 1, further comprising sending at least one utility value to at least one other access point in the wireless communication system.

8. The method of claim 1, further comprising preparing a list of potential client devices to be associated with the access point, wherein the potential client devices are selected from the at least one client device.

9. The method of claim 8, further comprising receiving a utility value for the at least one potential client device computed by at least one other access point in the wireless communication system.

10. The method of claim 9, wherein the determining whether the at least one client device is to be associated with the access point further comprises comparing the computed utility value with the received utility value.

11. The method of claim 10, further comprising notifying the at least one client device about the association if the computed utility value is greater than the received utility value.

12. An access point comprising:
a processor;
one or more network interfaces for establishing connection with one or more client devices and other access points in a wireless communication system;
a transceiver for communicating with the client devices and the other access points;
a memory comprising:
an information module configured to receive at least one client parameter and required throughput from the one or more client devices;
a rate module configured to compute an achievable transmission rate for the one or more client devices based on the respective client parameter, and to estimate throughput for the one or more client devices based on the computed achievable transmission rate;
a utility module configured to compute a utility value considering an association of a first client device, selected from the one or more client devices, with the access point based on the estimated throughput of the first client device and the throughput requirement of the first client device;
a comparison module configured to compare the computed utility value with utility values received from the other access points; and
an association module configured to allow the first client device to associate with the access point based on the comparison.

13. The access point of claim 12, wherein the rate module is configured to estimate throughput further based on transmission rate of at least one client device pre-associated with the access point.

14. The access point of claim 12, wherein the rate module is further configured to prepare a list of potential client devices to be associated with the access point based on the achievable transmission rate of each of the client devices.

15. The access point of claim 12, wherein the utility module is further configured to send at least one utility value to the other access points in the wireless communication system.

16. The access point of claim 12, wherein the association module is further configured to notify the first client device about the association.

17. A method for facilitating association of one or more client devices with an access point in a wireless communication system, the method comprising:
determining that a new client device is present in a coverage area of the access point;
receiving at least one client parameter and required throughput from the new client device;
computing an achievable transmission rate for the new client device based on the client parameter;
estimating throughput for the new client device based on the achievable transmission rate;
computing a utility value considering an association of the new client device with the access point, based on the estimated throughput and the required throughput of the new client device;
determining whether the new client device is to be associated with the access point based on the computed utility value;
associating the new client device with the access point based on the determination;
computing a change in utility value of the access point due to the association with the new client device;
disassociating one or more client devices previously associated with the access point based on the computed change; and
associating the disassociated client devices with other access points in the wireless communication system.

18. The method of claim 17, further comprising determining that a pre-associated client device has disassociated from the access point.

19. The method of claim 18, wherein the disassociation occurs due to at least one of a powering down, or a device failure, or departure of the client device.

20. The method of claim 18, further comprising computing a change in the utility value of the access point due to the disassociation of the pre-associated client device.
